(19) United States
(12) Patent Application Publication
(10) Pub. No.: US 2006/0185937 A1
(43) Pub. Date: Aug. 24, 2006

(54) Containment device

(75) Inventors: Adrian Barclay Caroen, Hove, East Sussex (GB); Michael James Webster, London (GB)

Correspondence Address: Marina Larson & Associates, LLC, P.O. BOX 4928, DILLON, CO, 80435, US

(73) Assignee: Stannah Stairlifts Limited, Andover, Hampshire (GB)

(21) Appl. No.: 10/549,551

(22) PCT Filed: Mar. 3, 2004
(86) PCT No.: PCT/GB04/00878

§ 371 Date: Sep. 19, 2005

(30) Foreign Application Priority Data
Mar. 20, 2003 (GB) 0306374.0

(51) Int. Cl. B60R 22/34; B66B 9/08

(52) U.S. Cl. 187/201; 297/475

(57) ABSTRACT

A containment device is described which has been developed for use on stairlift chairs, but may have a variety of other applications. The containment device includes a belt (26) retractably wound onto a reel. The reel is, in turn, mounted in a carrier (28). In operation, the carrier (28) is displaced to a locking point, the act of displacement unwinding the belt from the reel. When the carrier (28) is locked in position the belt (26) is locked with respect to the reel. Other features, particularly relevant to stairlift applications, are described.

### FIELD OF THE INVENTION

This invention relates to a containment device. Whilst the invention has been developed, in particular, to provide a containment device in the form of a retractable belt for containing the user of a stairlift in a stairlift chair, it will be appreciated that the containment device as described and claimed herein could be used in a variety of applications.

### BACKGROUND TO THE INVENTION

Many practical applications involve the use of web or belt wound onto a reel. Examples include motor vehicle safety belts, temporary crowd control barriers and certain forms of load restraint. In all these applications, the reel section is fixed. In use, the free end of the belt is drawn away from the reel section to unwind the belt from the reel. The free end of the belt is then fixed in position by, for example, an interlocking buckle and socket, one component of which is fixed to the free end of the belt. A retracting mechanism is provided within the reel to rewind the belt onto the reel when the buckle/socket is released.

A containment device of the general type described, has been used on stairlifts to provide a means to contain the stairlift user in the chair of the stairlift, as the stairlift carriage moves up and down the stairlift rail. In the stairlift application, the particular type of safety belt used is commonly known as an ambulance belt. To activate this type of device, the belt is drawn from the reel and a buckle, provided on the free end of the belt, inserted into a locking socket. As soon as the action of drawing the belt from the reel is stopped or even paused, the position of the belt relative to the reel is locked; and the belt cannot be drawn out any further. If the belt is not sufficiently extended then the belt first has to released and allowed to re-wind on to the reel, to at least some extent, before being re-extended.

These existing stairlift applications, as described above, have a number of drawbacks. Firstly the reel on the one hand, and the locking socket on the other, are typically mounted at opposite rear corners of the chair. This mounting arrangement thus allows the belt to extend across the lap. As the typical stairlift user has limited mobility, it can be awkward for such a user to locate the reel somewhere behind his or her hip, draw the buckle out from the reel, and then locate the buckle in its locking socket located behind the opposite hip. As a consequence users often do not bother to use the safety belt.

A second drawback is that, if a user pauses whilst drawing the belt from the reel and passing the belt over the lap, the belt locks. Thus the user has to let the belt retract, and start again. Again the fiddly nature of this process discourages use of the belt, particularly by those whose dexterity is impaired.

Finally, the engagement of the buckle into its locking fixture can be quite fiddly, particularly if the operation has to be carried out unsighted as is typically the case in stairlift applications. This problem is exacerbated if the user has limited manual dexterity, a characteristic of arthritis sufferers who make up a significant body of stairlift users.

It is an object of the present invention to provide a containment device which will go at least some way to addressing the aforementioned drawbacks; or which will at least provide a novel and useful choice.

### SUMMARY OF THE INVENTION

Accordingly, in one aspect, the invention provides a containment device including a reel mounted for rotation in a reel carrier; a length of web wound onto, and fixed at one end to, said reel and having an opposite free end, said restraint being characterized in that: said free end is, in use, fixed to an installation, said reel carrier being displaceable from the fixing point of said free end to unwind said web.

Preferably said reel carrier includes a fixing component thereon wherein, in use, said reel carrier may be engaged with a corresponding fixing component forming part of said installation.

Preferably said containment device further includes locking means operable to lock the position of said web or belt with respect to said reel housing, said device being characterised in that the act of engaging the fixing component of said reel carrier to the fixing component of said installation causes said locking means to operate.

Preferably said reel is locked within said reel carrier.

Preferably said device further includes retraction means to re-wind said belt onto said reel.

Preferably said reel carrier includes a housing sized and shaped to locate comfortably within a user's hand.

Preferably the point at which said belt enters and exits said reel carrier is surrounded by a support member.

Preferably said support member has a degree of flexibility which is less than the flexibility of said belt.

In a second aspect the invention comprises a stairlift chair including the containment device as hereinbefore set forth.

Preferably said stairlift chair includes two spaced armrests, the free end of said belt being attached to one of said armrests, and said reel housing being removeably connectable to a fixing component attached to the other of said armrests.

Preferably each of said armrests includes a forward edge and a rear edge, said containment device extending between points on said armrests closer to the forward edges than said rear edges thereof.

Preferably the point of connection between said reel carrier and said armrest is within the sight of a stairlift user.

Preferably said stairlift chair includes a further belt configured to, in use, pass over a shoulder of a user, said further belt being connected to, or being adapted to connect to, said reel carrier.

In a third aspect the invention provides a stairlift chair having a pair of spaced armrests and a containment device operable to, in use, retain a stairlift user within said chair, said chair being characterized in that part of said containment is mounted on one of said armrests, and part of said containment device, in use, removeably engages with the other of said armrests.

Preferably each of said armrests includes a forward edge and a rear edge, said containment device, in use, extending between points on said armrests closer to the forward edges than said rear edges thereof.

Preferably said containment device includes a reel carrier; a reel rotatably mounted within said reel carrier; and a belt wound onto said reel and having a free end, wherein said free end is fixed to one of said armrests and said reel carrier is removeably connectable to a fixing component on the other of said armrests.

In a fourth aspect the invention provides a stairlift chair having a containment device, said containment device including a belt wound on a reel and being extendible between a retracted configuration in which said containment device does not inhibit movement of a user into or out of said chair, and an extended position in which said containment device inhibits the movement of said user from said chair, said containment device being characterized in that the act of fixing said containment device in said extended position fixes said belt with respect to said reel.

Preferably said containment device further includes a reel carrier in which said reel is rotatably mounted, said containment device being further characterized in that said reel carrier is moveable to said extended position.

In a fifth aspect the invention provides a stairlift chair having a containment device, said containment device including a fixing component;

a reel carrier displaceable toward, and engageable with, said fixing component;

a reel rotatably mounted within said reel carrier;

a first belt fixed to said reel for winding on to, and from, said reel; and

a second belt fixed at one end to said chair and at the other end to said reel carrier,

one of said first and second belts being configured to pass over the lap of a user and the other of said first and second belts being configured to pass over a shoulder of a user.

In a sixth aspect the invention provides a stairlift including the stairlift chair and/or containment device as hereinbefore set forth.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future. The scope of the invention should be limited by the appended claims alone.

### BRIEF DESCRIPTION OF THE DRAWINGS

One embodiment of the invention, as applied to a stairlift, will now be described with reference to the accompanying drawings in which:

FIG. 1A: shows an isometric view of a stairlift installation fitted with a containment device according to the invention, in a first configuration;

FIG. 1B: shows a similar view to FIG. 1A, but with the containment device in a second configuration;

FIG. 2: shows an isometric view, from above and in larger scale than FIG. 1, of the reel carrier of a containment device according to the invention, in a fixed extended configuration;

FIG. 3: shows an isometric view, from underneath, of that which is shown in FIG. 2;

FIG. 4: shows a similar view to FIG. 3 but with the reel carrier in a position just out of engagement;

FIG. 5: shows an isometric view, in a larger scale than FIGS. 2 to 4, of a reel carrier in the fixed extended position, partly cutaway to show the internal operation thereof;

FIG. 6: shows a similar view to FIG. 5 but with the reel carrier disengaged from its fixing socket;

FIG. 7: shows an isometric view of further internal components of the reel carrier shown in FIGS. 2 to 6;

FIG. 8: shows an isometric view, from above, of a socket into which the reel carrier may locate to define a containment device according to the invention;

FIG. 9: shows a cross-section though the connection between the reel carrier and the socket.

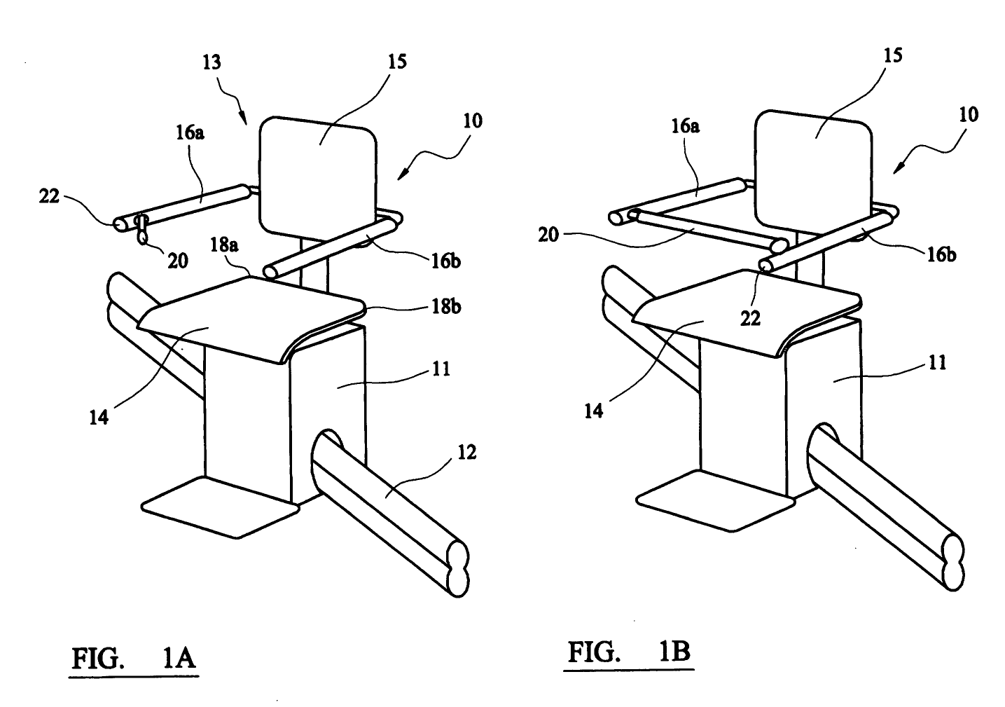

Figures: show similar views to FIGS. 1A and 1B but showing an 10A & 10B added containment component.

### DETAILED DESCRIPTION OF WORKING EMBODIMENT

In its broadest aspect the invention provides a containment device which has, as its basis, a length of web or belt material wound on to a rotatable reel. Such a containment device will be described in detail herein as applied to a stairlift chair. It should be appreciated, however, that a containment device as described herein could be applied to many other applications including, but not limited to, crowd control and load retention.

Referring firstly to FIGS. 1A and 1B, a stairlift installation 10 is depicted which includes a stairlift carriage 11 mounted on a stairlift rail 12 for movement up and down the rail. Mounted, in turn, on the carriage 11 is a chair 13. In the conventional manner, the chair 13 has a seating surface 14, a backrest 15 and a pair of spaced armrests 16a and 16b.

The installation 10 further includes a containment device which will be described in greater detail below. Broadly, this containment device takes the form of a belt wound on a reel, the belt being extendible from the reel, and being connectable to a spaced connection point, to overlie a stairlift user and prevent the user from unintentionally departing from the chair 13.

Heretofore, stairlift chairs have been provided with a containment device in the form of a retractable seat belt, the seat belt reel being mounted adjacent one rear corner 18a of the seating surface 14, and the belt buckle engaging a socket mounted adjacent the other rear corner 18b. Locating the belt components in positions 18a and 18b makes it difficult for persons having limited movement, and particularly limited manual dexterity, to locate and fasten the seat belt. As a consequence the seat belt is often not used.

Thus, in one aspect, the invention addresses the above drawback by providing a containment device or seat belt which is mounted on, and extends between, the armrests 16a and 16b.

In the form shown in FIGS. 1A and 1B, the seat belt assembly 20 is fixed to armrest 16a and can be drawn across to engage with armrest 16b. Further, it will be evident from FIGS. 1A and 1B that the assembly 20 is mounted closer to the forward ends 22 of the armrest than to the rear ends. In this way the assembly 20 falls readily to the hand of a user seated in the chair 13 and is preferably within the sight of a user. Thus a user is encouraged to apply the seat belt and finds it relatively easy to do so.

Whilst, in the arrangement shown in FIGS. 1A and 1B, a conventional seat belt reel could be fixed to armrest 16a and a conventional seat belt socket applied to armrest 16b, we have observed that conventional seat belt arrangements can be fiddly to operate, particularly by persons having impaired manual dexterity. It is not uncommon to find stairlift users having impaired manual dexterity, particularly as a result of suffering from arthritis. To this end, we have devised a novel form of containment device particularly suited for use by persons having limited manual dexterity. More particularly, we have devised a form of seat belt which, unlike the ambulance-type seatbelts used on stairlifts in the past, does not lock the belt in position should the user pause when drawing the belt from the reel.

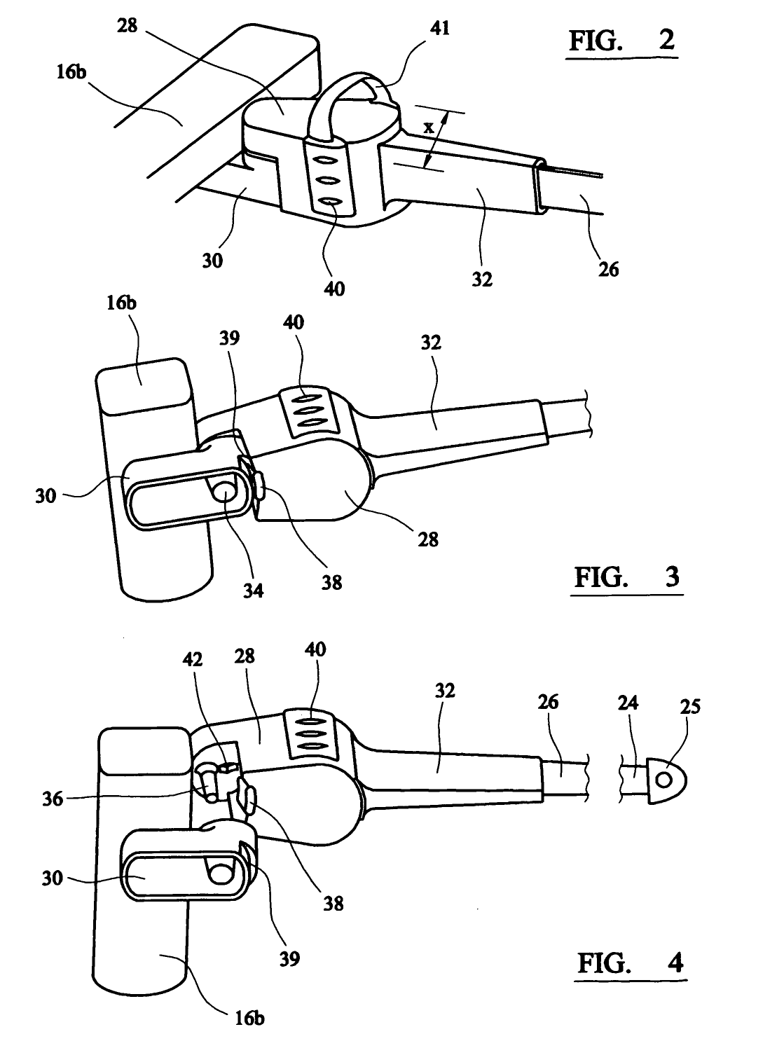

Turning now to FIGS. 2 to 4, the present invention further provides a containment device in which the free end 24 of the belt 26 is fixed to armrest 16a by means of anchor plate 25 (FIG. 4) whilst a reel carrier in the form of reel housing 28 (in which a reel with belt 26 wound thereon is housed) is displaceable between the armrests and can be engaged with fixing component 30 mounted on the armrest 16b. Obviously, as the reel housing is displaced in the direction of the armrest 16b, belt 26 is unwound from the reel. As will be described in greater detail below, the act of engaging reel housing 28 with the fixing component 30 activates a locking mechanism which causes the belt 26 to be locked with respect to the housing 28. Thus the belt provides an effective form of containment.

When disengaged as shown in FIG. 1A, the reel housing hangs beneath the armrest 16a. When a user is seated in the chair 13, the user grasps the housing, draws it across the body, and engages the housing with fixing component 30.

It will be noted that the housing 28 has a tapered form and is shaped for comfortable reception in the hand of a user. The width x of the housing (FIG. 2) is approximately the width of the palm of a typical hand (say 65 mm) and does not require the hand to be closed tightly around the housing for the housing to be manipulated into position. As can be seen, at the rear of the housing where the belt 26 enters and exits the housing, there may be provided a support member 32. This support member 32 is in the form of a sleeve which surrounds part of the belt 26. The support member 32 is preferably formed from a rubber or plastics material that has a degree of flexibility which is substantially less than the flexibility of the belt 26. In some situations, the presence of support member 32 may assist the task of grasping the housing 28 when in the disengaged configuration, and of effecting the connection with fixing component 30.

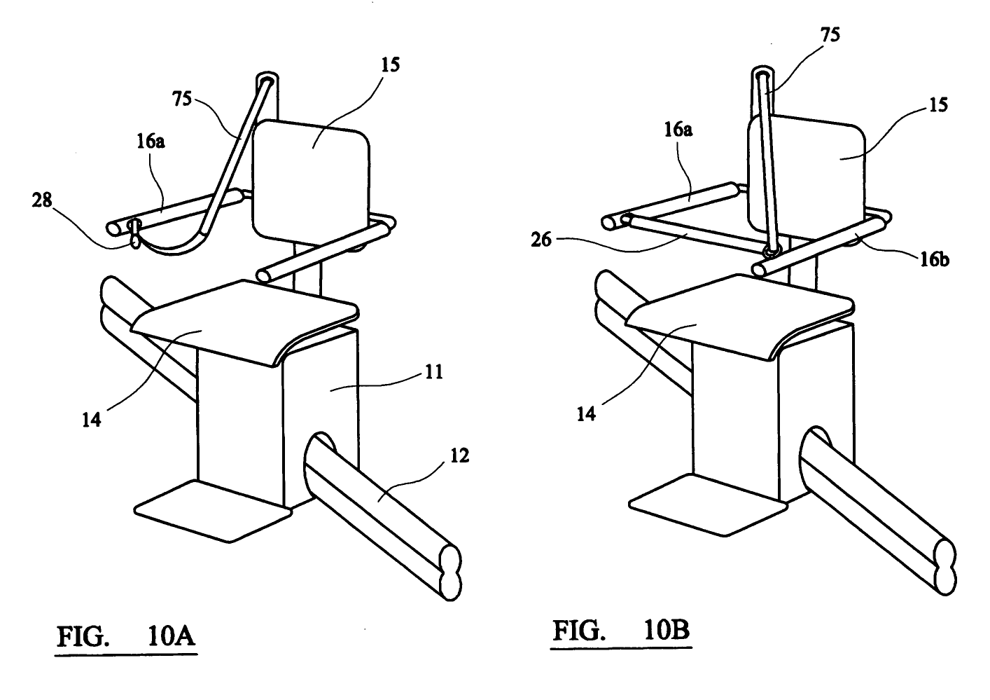

The principal connection between the reel housing 28 and the fixing component 30 is preferably effected by means of a co-operating pin and socket arrangement. In the particular form shown, the fixing component has an upwardly facing socket 34 (FIG. 8) whilst the reel housing 28 has a downwardly projecting pin 36. As can best be seen from FIG. 9, both the socket 34 and the pin 36 have downward tapers. Thus, as the pin 36 first enters the socket 34, there is considerable clearance between the two components. This makes it easy for a user to effect the initial connection. Once the initial connection has been made, the user merely applies downward pressure to the reel housing 28 to latch the two components together. This latching action is achieved by the interaction of spring loaded latch 38 on the reel housing projecting beneath ledge 39 formed in the fixing component 30. Release pads 40 mounted on the sides of the housing 28 provide the means by which the latching action may be released, the mechanism being described in greater detail below.

As stated above, apparatus of the type described herein will often be used by persons having restricted manual dexterity. Such persons may have difficulty manipulating the release pads 40 and, for that reason, the tops of the pads may be interconnected by a flexible strap 41 (FIG. 2). In use, a user may slide his/her hand through the strap and thus be able to release the latching action without any finger manipulation of the pads 40.

A further advantage of the strap 41 is that it allows the reel housing to be readily grasped and positioned. Indeed, the inclusion of the strap 41 may avoid the need to provide the support 32 of the rear of the reel housing.

A particularly preferred aspect of the containment device described herein is that, when the housing 28 is engaged with fixing component 30, locking means operate to lock the position of the belt 26 with respect to the housing 28. To this end, the reel housing 28 is further provided with a displaceable projection 42, the projection engaging an upper surface part 43 of the fixing component 30 as the housing 28 is engaged with the component 30. As will be described in detail below, displacement of the projection 42 as the containment components are engaged, causes the reel to be locked against further rotation.

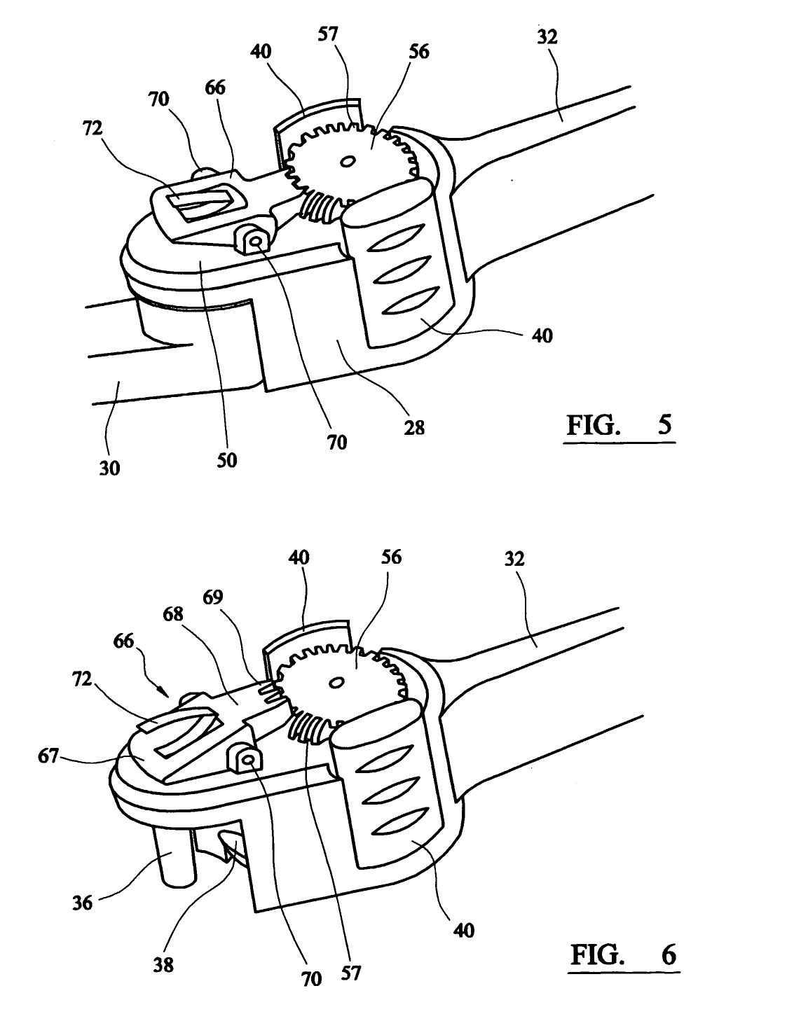

Turning finally to FIGS. 5 to 7, these figures show internal components of the reel housing 28 which perform the functions described generally above. As can be seen in FIG. 7, the internals of the reel housing 28 include a main base plate 50 and a bottom plate 52, the plate 52 being positioned in relation to plate 50 by means of spacers 53. Reel 54, upon which belt 26 is wound, is rotatably mounted between the plates 50 and 53. Preferably located within reel 54 is a retracting mechanism (not shown) which may be of any known or suitable form and could, for example, comprise a torsion spring. Located above plate 50, but fixed to reel 54 to rotate therewith, is a gear wheel 56 having radially projecting teeth 57 provided thereon.

Held against the underside of main plate 50 is the latching mechanism which holds the reel housing 28 in engagement with fixing component 30. As can be seen, latch 38 is defined at the lower end of latch arm 58, the latch arm being mounted, in turn, on cross bar 60. At the outer ends of the cross bar 60, and positioned at opposite sides of the assembly shown in FIG. 7, are mounted substantially triangular plates 62, each plate 62 having a tapered aperture 63 therein. Upon assembly of the reel housing 28, projections (not shown) provided on the inner surfaces of the release pads 40, locate in the apertures 63 and thus allow the latch 38 to be pivoted, about the axis of cross bar 60, by upward movement of either or both of the release pads 40.

The engagement pin 36 can be seen projecting from the underside of the plate 50 and may be formed integrally therewith. Provided within the base plate 50, adjacent the position of the pin 36, is an aperture 65 through which displaceable projection 42 projects.

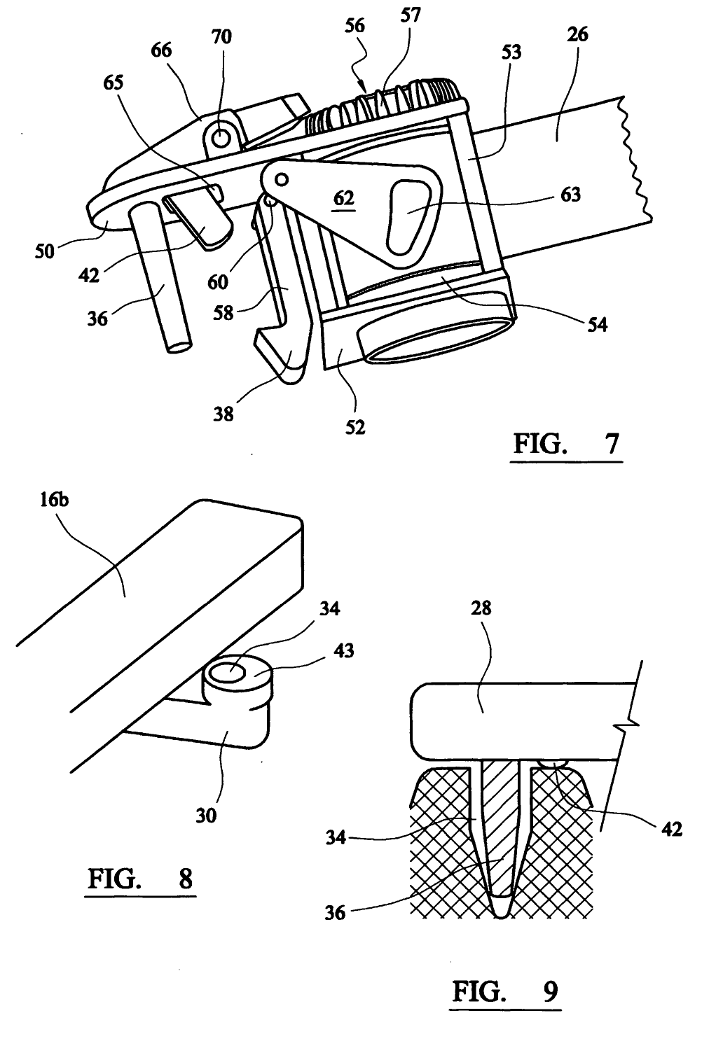

Turning to FIGS. 5 and 6, the projection 42 is fixed to, or formed as part of, the underside of moveable pawl 66, the pawl having a rear section 67, from which projection 42 projects, and a front section 68 having radially extending teeth 69 sized and arranged to mesh with the teeth 57 on gear wheel 56. The pawl 66 is pivotally mounted between brackets 70 provided on the upper surface of base plate 50 and is biased into the position shown in FIG. 6, where the pawl 66 is disengaged from gear wheel 56, by spring 72. Spring 72 acts between the pawl 66 and the underside of the casing defining the finished outer surface of reel housing 28. When the two sections of the containment device are engaged, the action of the projection 42 against the surface 43 causes the pawl to pivot into the position shown in FIG. 5 in which the teeth 67 mesh between teeth 57 thus locking the reel 54 against rotation.

It is envisaged that the pawl 66 may further include an active or ‘plastic’ hinge 74 to allow the reel housing 28 to be engaged with the fixing component 30 when the teeth 69 on the pawl overlie or clash with, the teeth 57 on gear wheel 56. The provision of the hinge 74 ensures a degree of bias is imposed by the teeth 69 on the gear wheel 56 and, when the belt 26 moves to even a small extent to allow the teeth 57 and 69 to mesh, they are indeed meshed.

The invention also envisages a more secure form of containment device in the form of a three-point linkage. Referring to FIGS. 10A & 10B, chair 13 may be provided with a further belt 75 configured to pass over the shoulder of a user. In the form shown, the one end of the further belt 75 is attached to post 77, the post 77, in turn, projecting upwardly from the chair backrest 15. The other end of further belt 75 is attached to the real housing 28.

When the stairlift is not in use, as shown in FIG. 10A, the belt 26 is retracted within reel housing 28 and the reel housing 28 is suspended beneath the armrest 16a. The further belt 75 hangs in a loop to that side of the chair on which armrest 16a is mounted.

When a user occupies the chair and draws reel housing 28 over to engage with fixing component 30, the further belt 75 is drawn across the chest to give a greater degree of restraint than that offered by a single belt.

Whilst in the form shown, the belt 26 which passes over the lap, is shown mounted within the reel housing 28, conceivably the belt 75 could be the retractable belt and the belt 26 allowed to hang when the stairlift is not in use.

Whatever the form the containment device might take, it is envisaged that an electrical interlock (not shown) may be included, either in the reel housing 28 and/or in the fixing component 20, to prevent the carriage 11 being powered along the rail 12 when the containment device is not secured.

It will thus be appreciated that the present invention, at least in the case of the working embodiment described herein, provides an effective containment device which is particularly suitable for operation by stairlift users having limited manual dexterity but could also find ready application in a variety of other fields.

1. A containment device including a reel mounted for rotation in a reel carrier; a length of web wound onto, and fixed at one end to, said reel and having an opposite free end, said restraint being characterized in that said free end is, in use, fixed to an installation, said reel carrier being displaceable from the fixing point of said free end to unwind said web.

2. A containment device as claimed in claim 1 wherein said reel carrier includes a fixing component thereon wherein, in use, said reel carrier may be engaged with a corresponding fixing component forming part of said installation.

3. A containment device as claimed in claim 2 further including locking means operable to lock the position of said web or belt with respect to said reel housing, said device being characterised in that the act of engaging the fixing component of said reel carrier to the fixing component of said installation causes said locking means to operate.

4. A containment device as claimed in claim 3 wherein said locking means operates to lock said reel within said reel carrier.

5. A containment device as claimed in claim 1 further including retraction means to retract said belt into said reel carrier.

6. A containment device as claimed in claim 1 wherein said reel carrier comprises a housing sized and shaped to locate comfortably within a user's hand.

7. A containment device as claimed in claim 1 wherein the point at which said belt enters and exits said reel carrier is surrounded by a support member.

8. A containment device as claimed in claim 7 wherein said support member has a degree of flexibility which is less than the flexibility of said belt.

9. A stairlift chair including the containment device as claimed in claim 1.

10. A stairlift chair as claimed in claim 9 including two spaced armrests, the free end of said belt being attached to one of said armrests, and said reel carrier being removeably connectable to a fixing component attached to the other of said armrests.

11. A stairlift chair as claimed in claim 10 wherein each of said armrests includes a forward edge and a rear edge, said containment device extending between points on said armrests closer to the forward edges than said rear edges thereof.

12. A stairlift chair as claimed in claim 11 wherein the point of connection between said reel carrier and said armrest is within the sight of a stairlift user.

13. A stairlift chair as claimed in claim 9 including a further belt configured to, in use, pass over a shoulder of a user, said further belt being connected to, or being adapted to connect to, said reel carrier.

14. A stairlift chair having a pair of spaced armrests and a containment device operable to, in use, retain a stairlift user within said chair, said chair being characterized in that part of said containment is mounted on one of said armrests, and part of said containment device, in use, removeably engages with the other of said armrests.

15. A stairlift chair as claimed in claim 14 wherein each of said armrests includes a forward edge and a rear edge, said containment device, in use, extending between points on said armrests closer to the forward edges than said rear edges thereof.

16. A stairlift chair as claimed in claim 15 wherein said containment device includes a reel carrier; a reel rotatably mounted within said reel carrier; and a belt wound onto said reel and having a free end, wherein said free end is fixed to one of said armrests and said reel carrier is removeably connectable to a fixing component on the other of said armrests.

17. A stairlift chair having a containment device, said containment device including a belt wound on a reel and being extendible between a retracted configuration in which said containment device does not inhibit movement of a user into or out of said chair, and an extended position in which said containment inhibits the movement of said user from said chair, said containment device being characterized in that the act of fixing said containment device in said extended position fixes said belt with respect to said reel.

18. A stairlift chair as claimed in claim 17 wherein said containment device further includes a reel carrier in which said reel is rotatably mounted, said containment device being further characterized in that said reel carrier is moveable to said extended position.

19. A stairlift chair having a containment device, said containment device having a fixing component; a reel carrier displaceable toward, and engageable with, said fixing component; a reel rotatably mounted within said reel carrier; a first belt fixed to said reel for winding on to, and from, said reel; and a second belt fixed at one end to said chair and at the other end to said reel carrier, one of said first and second belts being configured to pass over the lap of a user and the other of said first and second belts being configured to pass over a shoulder of a user.

20. A stairlift including a stairlift chair and a containment device as claimed claim 1.

21. A containment device as claimed in claim 1 further including locking means operable to lock the position of said web or belt with respect to said reel housing, said device being characterised in that the act of engaging the fixing component of said reel carrier to the fixing component of said installation causes said locking means to operate.

22. A stairlift chair as claimed in claim 10 wherein the point of connection between said reel carrier and said armrest is within the sight of a stairlift user.

23. A stairlift chair as claimed in claim 14 wherein said containment device includes a reel carrier; a reel rotatably mounted within said reel carrier; and a belt wound onto said reel and having a free end, wherein said free end is fixed to one of said armrests and said reel carrier is removeably connectable to a fixing component on the other of said armrests.
